(19) United States
(12) Patent Application Publication
(10) Pub. No.: US 2014/0119586 A1
(43) Pub. Date: May 1, 2014

(54) HEARING AID ASSEMBLY

(71) Applicant: Sonion A/S, Roskilde (DK)

(72) Inventors: Mads Buur Mortensen, Copenhagen N (DK); Flemming Risager, Næstved (DK); Paul Christiaan van Hal, Amsterdam (NL); Adrianus Maria Lafort, Delft (NL); Andreas Tiefenau, Koog a/d Zaan (NL)

(73) Assignee: Sonion A/S, Roskilde (DK)

(21) Appl. No.: 14/061,148

(22) Filed: Oct. 23, 2013

Related U.S. Application Data
(60) Provisional application No. 61/718,562, filed on Oct. 25, 2012.

(51) Int. Cl. H04R 25/00

(52) U.S. Cl. CPC H04R 25/65
USPC 381/330

(57) ABSTRACT

A hearing aid assembly comprising: a behind-the-ear part adaptor which is adapted to be connected to a behind-the-ear part; an ear piece which is adapted to be secured in the auditory canal of a user, such that sound may propagate into the auditory canal; and an interconnecting tube which is arranged between the behind-the-ear part adaptor and the ear piece, the interconnecting tube defining a first lumen and a second lumen each of which interconnects the behind-the-ear part adaptor and the ear piece, and wherein the interconnecting tube comprises a first connector and the behind-the-ear part adaptor comprises a second connector, the first and the second connectors being adapted to be connected to each other such that interconnecting tube is connected to the behind-the-ear part adaptor.

### CROSS-REFERENCE TO RELATED APPLICATION

This application claims the benefit of U.S. Provisional Patent Application No. 61/718,562, filed Oct. 25, 2012, entitled “A Hearing Aid Assembly” which is hereby incorporated by reference in its entirety.

### FIELD OF THE INVENTION

The present invention relates to a hearing aid assembly comprising a behind-the-ear part assembly, an ear piece and an interconnecting tube. The behind the ear part adaptor is adapted to be connected to a behind-the-ear part.

### BACKGROUND OF THE INVENTION

The present invention relates to a hearing aid assembly comprising:

a behind-the-ear part adaptor which is adapted to be connected to a behind-the-ear part; an ear piece which is adapted to be secured in the auditory canal of a user, such that sound may propagate from the ear piece into the auditory canal; and
an interconnecting tube which is arranged between the behind-the-ear part adaptor and the ear piece, the interconnecting tube defining a first lumen and a second lumen each of which interconnects the behind-the-ear part adaptor and the ear piece, and
wherein the interconnecting tube comprises a first connector and the behind-the-ear part adaptor comprises a second connector, the first and the second connectors being adapted to be connected to each other such that interconnecting tube is connected to the behind-the-ear part adaptor.

### SUMMARY OF INVENTION

By providing a first and a second connector, the behind-the-ear part adaptor and the interconnecting tube may easily be connected and disconnected to each other. It will be appreciated that the interconnecting tubes may need replacement prior to the point in time where the behind-the-ear part adaptors need replacement. This is especially the case where the interconnecting tube and the ear piece are not detachably and re-attachably connected to each other. Thus by providing the first and the second connector, the interconnecting tube may be disconnected and a new—unused—tube may be connected to the behind-the-ear part adaptor. As the interconnecting tubes typically are inexpensive to manufacture compared to the behind-the-ear part adaptors, the provision of the first and the second connectors lowers the cost-of-use of the device

In one embodiment, the term ‘hearing aid assembly’ shall be understood as a kit of elements comprising a behind-the-ear part adaptor, an ear piece and an interconnecting tube. In the latter case, the elements need not be connected to each other. In another embodiment, the term shall be understood such that the elements are connected to each other, i.e. such that the interconnecting tube is connected to the behind-the-ear part adaptor and to the ear piece. In other words, the elements are assembled in the latter embodiment.

In yet another embodiment, the term shall also comprise a behind-the-ear part. Again, the behind-the-ear part may or may not be connected to the behind-the-ear part adaptor.

The behind-the-ear part adaptor is adapted to be connected to the behind-the-ear part. When this is done, sound may propagate from a receiver provided in the behind-the-ear part into the behind-the-ear part adaptor and further through the first lumen. Subsequently, the sound may enter the ear piece and continue from the ear piece and into the auditory canal of a user.

The interconnecting tube is arranged between the behind-the-ear part and the ear piece. In one embodiment, the interconnecting tube is permanently secured to the ear piece. By permanently secured shall be understood that the two units (the interconnecting tube and the ear piece) cannot be removed from each other without damaging or breaking one or both of the two elements. In one embodiment, the interconnecting tube is adhered to the ear piece. Alternatively, the two elements are welded or fused together such that a welding/fuse seam is formed between the two elements. In yet another embodiment, the interconnecting tube and the ear piece define a monolithic element i.e. one unitary elements without seams (e.g. welding or gluing seams) formed there between.

In one embodiment, the first lumen is—during use of the assembly—used to allow sound to propagate through the interconnecting tube and further through the ear piece. At the same time, the second lumen may be used for other purposes such as for accommodation of one or more electrical conductors or for providing air or any other fluid to an inflatable part of the ear piece as is described in further detail below.

The interconnecting tube may comprise polyamide, generally referred to as Nylon. Other suitable materials are polyether block amides, e.g. PEBAX.

The ear piece may be comprise Acrylic polymers, thermoplastic elastomers (TPE), Polyurethane (PU) or silicone rubber.

The behind-the-ear part adaptor may comprise one or more elements which are assembled into one unit. The one or more parts may comprise various materials including polymers and metals.

In one embodiment, the cross sectional area of the first and the second lumen are identical. In another embodiment, the first lumen has a larger cross-sectional area than the second lumen. As an example, the cross-sectional area of one of the first and the second lumen may be 25 per cent larger than the cross-sectional area of the other of the first and the second lumen, such as 50 per cent larger, such as 75 per cent larger, such as 100 per cent larger, such as 125 per cent larger, such 150 per cent larger, such as 200 per cent larger, such as 250 per cent larger, such as 300 per cent larger, such as 400 per cent larger, such as 500 per cent larger.

In one embodiment, the cross sectional area of the first lumen has a diameter ranging from 1.0 to 2.0 mm and/or the second lumen has a diameter ranging from 0.2 to 1.0 mm.

The length of the interconnecting tube may vary between 5 to 9 cm.

In order to allow the interconnecting tube and the behind-the-ear part adaptor to be detached and re-attached to each other, the first and a second connector are provided. In one embodiment, the one of the first and the second connectors is a plug while the other of the first and the second connectors is a socket.

The first and second connectors may comprise a locking means for securing the interconnecting tube to the behind-the-ear adaptor. In one embodiment, the locking means is a snap lock, i.e. a lock which automatically locks (snaps) when the first and the second connector are connected to each other. In another embodiment, the lock comprises a locking member which must be provided in a predetermined position in order to lock the first and the second connector to each other. One example of such a lock with a locking member, is a pin lock wherein a pin must be inserted into a passage in order to lock the first and the second connectors to each other.

The ear piece is adapted to be secured to the auditory canal of the user. In one embodiment, the ear piece is custom made such that is has an outer geometry corresponding to the geometry of the auditory canal of the user. In the latter embodiment, the ear piece may be moulded into the custom shape.

Alternatively, the ear piece is universal and as it may itself adapt its size and geometry to the geometry of the user. As an example, the ear piece defines an inflatable part, defining an inflatable cavity, which when inflated defines an inflated state in which the inflatable part abuts an inner wall of the auditory canal when provided therein, and a deflated state in which it allows for insertion and/or retraction of the ear piece from the auditory canal.

The inflatable cavity defines an inner volume which increases and decreases depending on whether the inflatable cavity is inflated or deflated, respectively. The inflatable part may define an outer surface of the ear piece. In one embodiment, an outer surface of the inflatable part defines a sphere. In another embodiment, the outer surface defines a donut—i.e. a Torus.

In one embodiment, the second lumen is fluidly connected to the inflatable part such that when fluid is pumped into the second lumen, the inflatable part is caused to inflate. By fluidly connecting the second lumen to the inflatable part, the latter may be inflated remotely by blowing air into the second lumen at the position of the behind-the-ear part adaptor. Similarly, the inflatable part may be deflated be releasing air from the second lumen in the area of the behind-the-ear part adaptor. In one embodiment, the second lumen is directly connected to the inflatable part.

It may be advantageous to have access to the second lumen from an outer surface of the hearing aid assembly, thus in one embodiment, the second lumen is fluidly connected to a fluid connector, which is provided on an outer surface of the behind-the-ear adaptor. The fluid connector may be a tube shaped element which extends away from the outer surface of the behind-the-ear part adaptor. In one embodiment the hardness of the fluid connector may be higher than the hardness of the interconnecting tube, i.e. the fluid connector is harder. In one embodiment, at least a part of the fluid connector is defined by the behind-the-ear part adaptor. As an example the fluid connector and the behind-the-ear part adaptor may define a monolithic element.

In order to allow the inflatable part to inflate, the hearing aid assembly may comprise a pump, which is fluidly connected to the second lumen. Thus when the pump is operated fluid, e.g. air is pumped into the second lumen and further into the inflatable part which is caused to expand. In one embodiment, the pump is a manual pump. The manual pump may be connected to the fluid connector which is provided on the outer surface of the behind-the-ear part adaptor. Thus, the manual pump is accessible from an outer surface of the hearing aid. In one embodiment, the manual pump is secured to the behind-the-ear part adaptor. Alternatively, or as a supplement, the manual pump may be secured the behind-the-ear part.

Thus when the ear piece has been inserted into the auditory canal, the user may cause the ear piece to expand by manually operating the pump provided on the outer surface.

The pump may be reused more often than the behind-the-ear part adaptor. Thus in one embodiment, the pump is detachably and re-attachably attached to the fluid connector. Accordingly when it is time to replace the behind-the-ear part adaptor, the pump may be disconnected and reconnected to a new behind-the-ear part adaptor.

In one embodiment, the pump is an automatic pump. The automatic pump may be provided externally from the behind-the-ear part adaptor e.g. by being connected to the fluid connector. Alternatively, the pump is integrated into (or just provided inside) one of the behind-the-ear part adaptor and the behind-the-ear part. The pump may be operable by means of an activation element (e.g. a switch) provided on an outer surface of the behind-the-ear part adaptor or the behind-the-ear part.

During use, the inflatable ear piece may be inserted into the auditory canal in a deflated state. Once the inflatable ear piece is inserted, it may be inflated by means of the pump to a desired inflation level. This level may be determined by the user operating the pump. When the inflatable ear piece is to be removed or if the inflatable part has been inflated too much, air must be removed. Thus, means allowing air to be removed must be provided. In one embodiment, a valve is arranged such that when provided in an open state, fluid may escape the second lumen and the inflatable cavity of the inflatable ear piece, and when provided in a closed state, fluid is prevented from escaping the second lumen and the inflatable cavity. In some embodiments, the valve functions as a unidirectional valve when provided in the closed state, i.e. such that air may be pumped into the second lumen when the valve is in the closed state while air is prevented from escaping the second lumen when the valve is in the closed state.

In one embodiment, the hearing aid assembly comprises the behind-the-ear part.

In order to allow the behind-the-ear part to generate sound, the behind-the-ear part may define/comprise a receiver which is fluidly connected to the first lumen, when the behind-the-ear part is attached to the behind-the-ear adaptor.

Alternatively or as a supplement a receiver may be provided in the ear piece. This receiver may be electrically connected to the behind-the-ear part. Thus in one embodiment, the hearing aid assembly comprises one or more electrical conductors which extend between the behind-the-ear part adaptor and the ear piece.

In one embodiment, one or more of electrical conductors is/are provided on an outer surface of the interconnecting tube. Alternatively, one or more of the electrical conductor(s) is/are provided in one of the first and the second lumen.

### BRIEF DESCRIPTION OF THE DRAWINGS

The invention will now be described with reference to the figures in which:

FIG. 1 discloses a first embodiment of the invention wherein no receiver is provided in the ear piece,

FIG. 2 discloses a second embodiment of the invention wherein a receiver is provided in the ear piece,

FIG. 3 discloses a side view of the behind-the-ear part adaptor and the interconnecting tube,

FIG. 4 discloses a cross sectional view of the behind-the-ear part adaptor and the interconnecting tube, and

FIG. 5 discloses an exploded view of the interconnecting tube and the behind-the-ear part adaptor,

FIG. 6 discloses a hearing aid comprising a manual pump for pumping air into the inflatable ear piece, and

FIG. 7 discloses a release button of the behind-the-ear part adaptor.

### DETAILED DESCRIPTION OF PREFERRED EMBODIMENTS

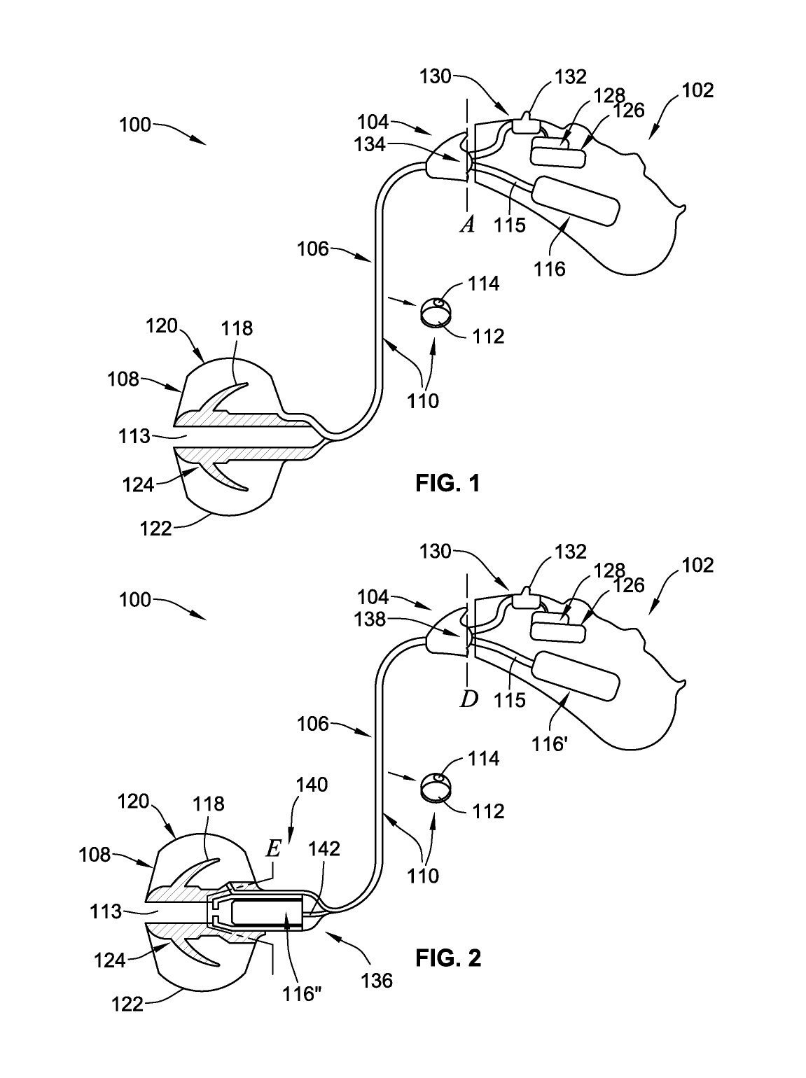

FIG. 1 discloses a hearing aid assembly 100 comprising a behind-the-ear part 102, a behind-the-ear part adaptor 104, an interconnecting tube 106 and an ear piece 108. The hearing aid assembly 100 comprises two parts which may be disconnected from each other. A first part comprising the behind-the-ear part 102 and a second part comprising the behind-the-ear part adaptor 104, the interconnecting tube 106 and the ear piece 108. From the FIG. 1 it will be appreciated that the interconnecting tube 106 interconnects the ear piece 108 and the behind-the-ear party adaptor 104. By allowing the behind-the-ear part adaptor 104 to be disconnected from the behind-the-ear part 102, the second part may be replaced by a new second part while at the same time reusing the first part (i.e. the behind-the-ear part adaptor 104 is replaced). It will be appreciated that as a part of the second part is located inside the auditory canal, it is used in a more vulnerable position than the behind-the-ear part 102. As an example, the auditory canal is more damp than the position behind the ear. Moreover, the ear piece 108 is subjected to cerumen which is greasy and tends to stick to the ear piece 108. In one embodiment, the interconnecting tube 106 is detachably connected to the behind-the-ear part adaptor 104 and/or to the ear piece 108. In another embodiment, the interconnecting tube 106 is permanently connected to one or both of the behind-the-ear part 102 and the behind-the-ear part adaptor 104.

The interconnecting part may define a bi-lumen system 110, defining a first lumen 112 and a second lumen 114. In the embodiment of FIG. 1, the first lumen 112 is at one end fluidly connected to a passage 113 of the ear piece 108 which allows sound to propagate into the auditory canal of the user. The other end of the first lumen 112 is connected to a receiver 116 of the behind-the-ear part 102 through a passage 115 defined in the behind-the-ear part 102 and the behind-the-ear part adaptor 104. Thus when sound is generated by the receiver 116 it propagated through the passage 115 in the behind-the-ear part adaptor 104, further through the first lumen 112 of the interconnecting tube 106 into the passage 113 of the ear piece 108, and further into the auditory canal of the user.

The second lumen 114 of the interconnecting tube is fluidly connected to an inflatable cavity 118 of the ear piece 108. The inflatable cavity 118 is arranged such that it defines an outer circumferential surface 120 of the ear piece. In one embodiment, the inflatable cavity 118 defines a torus/donut .In another embodiment, the inflatable cavity defines a sphere. When a fluid such as air, is pumped or blown into the inflatable cavity 118, the inflatable cavity 118 is caused to expand radially. Thus when provided inside the auditory canal of the user, the outer surface 120 of the inflatable cavity 118 will gradually be brought into to contact with an inner surface (not shown) of the auditory canal of the user. Once the desired pressure is applied to said inner surface, the pumping action may be halted by the user. Accordingly, by pumping air into the inflatable cavity 118 the ear piece 108 may be retained in the auditory canal. It will be appreciated that one advantage of the inflatable ear piece 108 is that it need not be customised to a specific user, as the user simply just adjusts the pressure to the desired level. Moreover, it will be realised that as the walls 122 of the inflatable cavity 118 are made of a flexible material (such that it is capable of expanding), the walls 122 will adjust their shape to the shape on the auditory canal of the user.

Inside the inflatable cavity, a dome 124 is provided which is arranged to bias the wall 122 of the inflatable cavity 118 away from a completely collapsed state.

In order to pump air into the inflatable cavity, a pump 126 is provided at the other end of the second lumen 112. A valve arrangement 128 is provided which secures that air blown into the second lumen 114 remains therein unless the user desires to remove the air. In order to be able to remove the air, the behind-the-ear part 102 is provided with a release valve 130 which is fluidly connected to the valve arrangement 128 and to the second lumen 114. Accordingly, if the user desires to remove the inflatable ear piece or if too much air has been blown into the inflatable cavity, the user may press the release valve 130 whereby the air contained inside the second lumen 114 and in the inflatable cavity 118, is free to escape. The release valve comprises a button 132 which is accessible from outside the behind-the-ear part 102.

As previously mentioned, the behind-the-ear part 102 and the behind-the-ear part adaptor 104 are detachable from each other. The area of separation is disclosed by line A, see ref. 134.

FIG. 2 discloses another embodiment of a hearing aid assembly 100 comprising a behind-the-ear part 102, a behind-the-ear part adaptor 104, an interconnecting tube 106 and an ear piece 108. The hearing aid assembly 100 comprises two parts which may be disconnected from each other. Elements which are identical to the elements of FIG. 1 have the same reference numbers.

One difference relative to FIG. 1 is that two receivers are provided. A first receiver 116′ which is provided in the behind-the-ear part 102, and a second receiver 116″ which is provided in the ear piece 108. In one embodiment, one of the two receivers 116′,116″ is a tweeter, while the other of the two receivers 116′,116″ is a woofer. In the embodiment of FIG. 2, the second receiver 116″ is a tweeter provided the ear piece 108 and the first receiver 116′ is a woofer provided in the behind-the-ear part 102. It will be appreciated that the woofer may be more space consuming and, thus, it may be advantageous to provide it in the behind-the-ear part 102 in which more space is available compared to in the ear piece.

The second receiver 116″ is provided in the ear piece 108. However as a receiver 116 is a relative expensive part of a hearing aid, it is desirable to be able to reuse the second receiver 116″ when the ear piece 108 is due for replacement e.g. due to being contaminated with cerumen. In order to address this problem, the invention according to FIG. 2 comprises three parts. A first part comprising the behind-the-ear part 102, a second part comprising the behind-the-ear part adaptor 104, the interconnecting tube 106 and a tweeter part 136, and a third part comprising the ear piece 108. Line D (ref 138) indicated the line between the first and the second part, and the line E (ref. 140) indicates the lines of separation between the second and third parts. It will be appreciated that in order to be able to generate sound with the second receiver 116″, one or more electrical conductors 142 must be provided for electrically connecting the behind-the-ear part with the second receiver 116″.

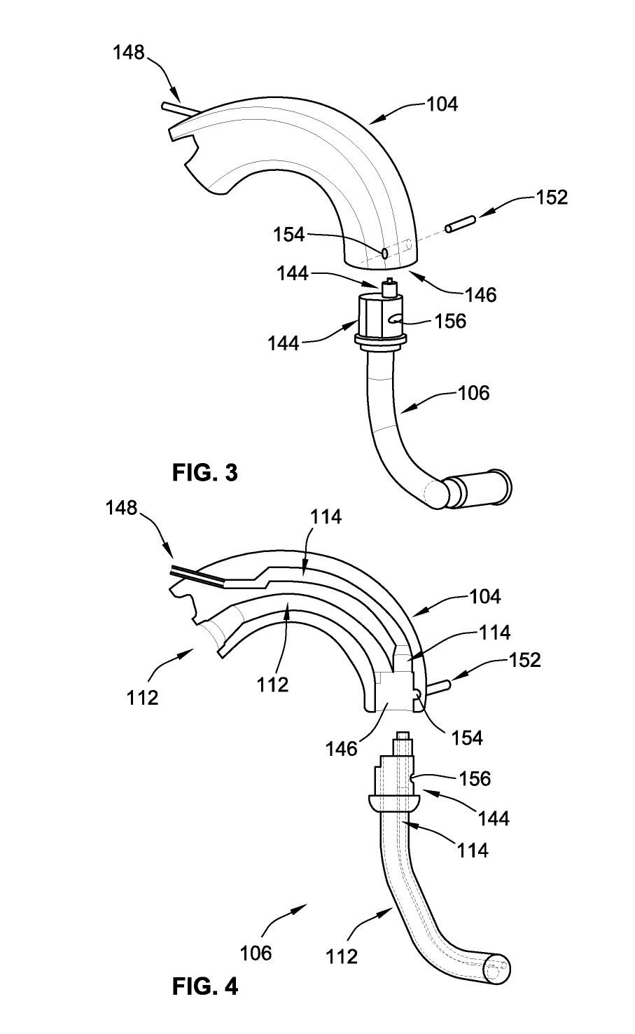

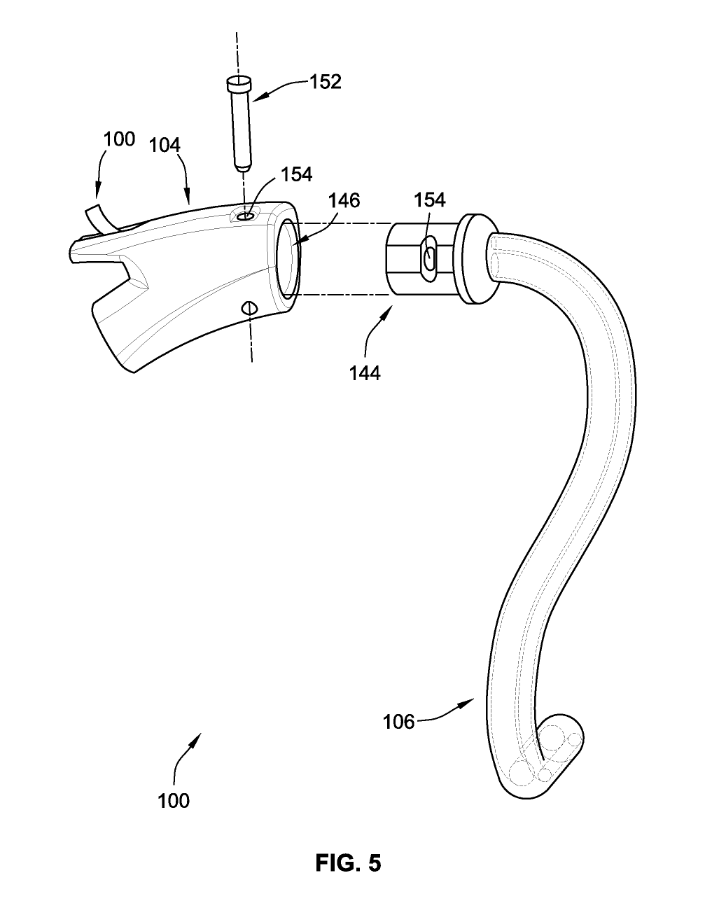

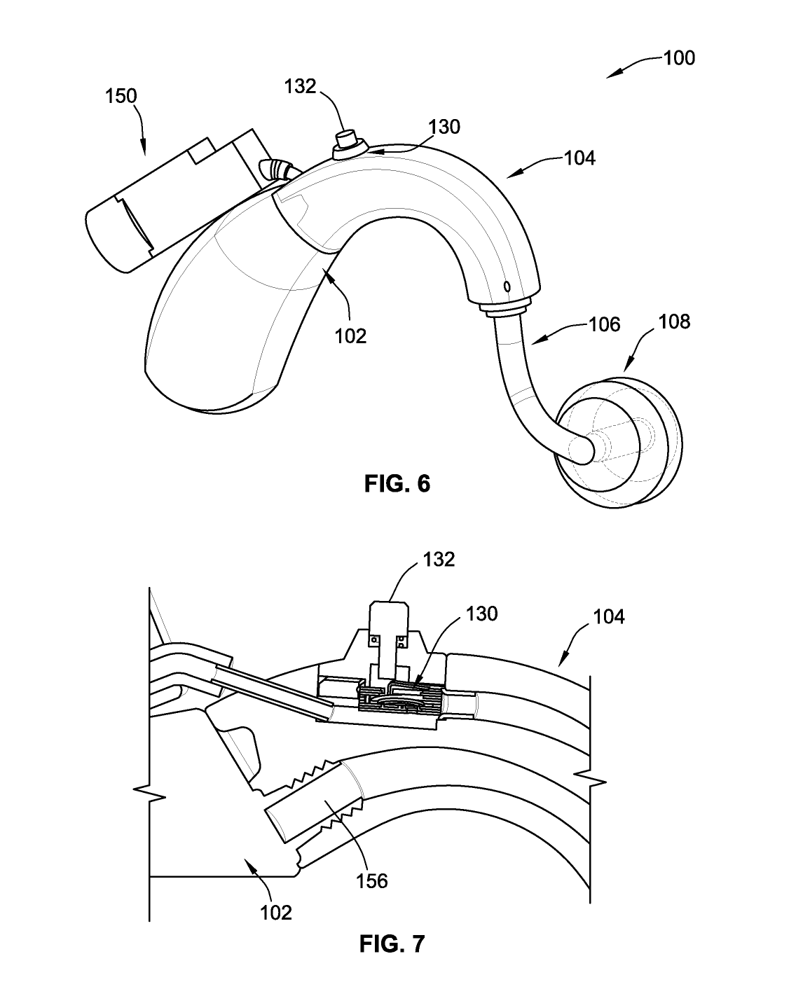

FIGS. 3-5 disclose an interconnecting tube 106 and a behind-the-ear part adaptor 104, which comprises a first connector 144 and a second connector 146, respectively. The first connector 144 defines a plug and the second connector 146 defines a socket. In order to connect the interconnecting tube to the behind-the-ear part adaptor 104, the plug 144 is inserted into the socket 146 where by the first lumen of the interconnecting tube 106 is fluidly connected to the first lumen of the behind-the-ear part adaptor 104. Similarly, the second lumen 114 of the interconnecting tube 106 and the behind-the-ear part adaptor 104 are fluidly connected to each other. The second lumen 114 of the behind-the-ear part adaptor 104 is fluidly connected to fluid connector 148 which is accessible from an outer surface of the behind-the-ear part adaptor 104, such that a pump 150 (see FIG. 6) may be connected to the second lumen 114. In order to secure the interconnecting tube 106 to the behind-the-ear part adaptor 104, a locking means is provided in the form of a pin shaped locking member 152 which is adapted to be inserted into a passage 154 which is defined when the plug 144 is inserted into the socket 146.

FIG. 6 discloses a hearing aid assembly 100 comprising a behind-the-ear part 102, a behind-the-ear part adaptor 104, an interconnecting tube 106, an ear piece 108. In order to pump air into the second lumen 114 and thus also into the inflatable cavity 118, a manual pump 150 is fluidly connected to the fluid connector 148 such that it is accessible from an outer surface of the hearing aid assembly 100. The manual pump 150 is detachably and re-attachably attached to the fluid connector whereby it may be reused when the behind-the-ear part adaptor 104 is to be replaced.

In order to be able to release air from the second lumen 114 and the inflatable cavity 118, a release valve 130 is provided. The release valve 130 is operable by the user from an outer surface of the hearing aid assembly 100 by means of a button 132. The release valve 130 defines an open state when the button 132 is depressed and a closed state when the release valve 130 is not depressed. The release valve 130 comprises means for biasing the valve 130 into the closed state.

It will be appreciated that the hearing aid assembly 100 may also in some embodiments comprise an electrical pump (not shown) which the user may operate by means of activation buttons (not shown) provided on an outer surface of the hearing aid assembly 100 e.g. on an outer surface of the behind-the-ear part 102 or the behind-the-ear part adaptor 104.

A receiver 116 is provided in the behind-the-ear part and in order for the sound generated by the receiver 116 to propagate in the first lumen, a first lumen connector 156 is provided which engages the first lumen 112 of the behind-the-ear part adaptor 104, when hearing aid assembly 100 is assembled.

1. A hearing aid assembly comprising:
a behind-the-ear part adaptor which is adapted to be connected to a behind-the-ear part;
an ear piece which is adapted to be secured in the auditory canal of a user, such that sound may propagate into the auditory canal; and
an interconnecting tube which is arranged between the behind-the-ear part adaptor and the ear piece, the interconnecting tube defining a first lumen and a second lumen each of which interconnects the behind-the-ear part adaptor and the ear piece, and
wherein the interconnecting tube comprises a first connector and the behind-the-ear part adaptor comprises a second connector, the first and the second connectors being adapted to be connected to each other such that interconnecting tube is connected to the behind-the-ear part adaptor.

2. A hearing aid assembly according to claim 1, wherein the ear piece defines an inflatable part, defining an inflatable cavity, which when inflated defines an inflated state in which the inflatable part abuts an inner wall of the auditory canal when provided therein, and a deflated state in which it allows for insertion and/or retraction of the ear piece from the auditory canal.

3. A hearing aid assembly according to claim 2, wherein the second lumen is fluidly connected to the inflatable part such that when fluid is pumped into the second lumen, the inflatable part is caused to inflate.

4. A hearing aid assembly according to claim 1, further comprising the behind-the-ear part.

5. A hearing aid assembly according to claim 1, wherein the second lumen is fluidly connected to a fluid connector, which is provided on an outer surface of the behind-the-ear adaptor or on an outer surface of the behind-the-ear part.

6. A hearing aid assembly according to claim 1, further comprising a pump, which is fluidly connected to the second lumen.

7. A hearing aid assembly according to claim 6, wherein the pump is a manual pump.

8. A hearing aid assembly according to claim 5, wherein the pump is detachably and re-attachably attached to the fluid connector.

9. A hearing aid assembly according to claim 6, wherein the pump is detachably and re-attachably attached to the fluid connector.

10. A hearing aid assembly according to claim 6, wherein the pump is an automatic pump.

11. A hearing aid assembly according to claim 10, wherein the pump is integrated into one of the behind-the-ear part adaptor and into the behind-the-ear part.

12. A hearing aid assembly according to claim 1, wherein a release valve is arranged such that when provided in an open state, fluid may escape the second lumen and the inflatable cavity of the inflatable ear piece, and when provided in a closed state, fluid is prevented from escaping the second lumen and the inflatable cavity.

13. A hearing aid assembly according to claim 1, wherein a locking means is provided for securing the interconnecting tube to the behind-the-ear adaptor.

14. A hearing aid assembly according to claim 1, wherein the behind-the-ear part defines a receiver which is fluidly connected to the first lumen, when the behind-the-ear part is attached to the behind-the-ear adaptor.

15. A hearing aid assembly according to claim 1, further comprising one or more electrical conductors which extend between the behind-the-ear part adaptor and the ear piece.

16. A hearing aid assembly according to claim 15, wherein the electrical conductor is provided in one of the first and the second lumen.
